(19) United States
(12) Patent Application Publication
(10) Pub. No.: US 2017/0217591 A1
(43) Pub. Date: Aug. 3, 2017

(54) Mounting Structure for Fixtures of an Aircraft Lavatory Unit

(71) Applicant: The Yokohama Rubber Co., LTD., Minato-ku, Tokyo (JP)

(72) Inventors: Ayano Hirose, Hiratsuka-shi, Kanagawa (JP); Takafumi Kobayashi, Hiratsuka-shi, Kanagawa (JP); Yuji Taguchi, Hiratsuka-shi, Kanagawa (JP)

(21) Appl. No.: 15/305,085

(22) PCT Filed: Dec. 22, 2014
(86) PCT No.: PCT/JP2014/083850

§ 371 Date: Oct. 18, 2016

(30) Foreign Application Priority Data
Apr. 24, 2014 (JP) 2014-089780

(51) Int. Cl. B64D 11/02; F16B 13/14; F16B 19/10; F16B 5/04

(52) U.S. Cl. CPC B64D 11/02; F16B 5/04; F16B 13/14; F16B 19/10

(57) ABSTRACT

A storage rack is mounted on a wall panel via a reinforcing thin sheet and a synthetic resin rivet. The reinforcing thin sheet is mounted on the inner surface of the surface member at a location at which the storage rack is arranged. A rivet insertion hole is formed penetrating the surface member and the reinforcing thin sheet. Leg pieces of the pre-assembled rivet are inserted into the rivet insertion hole from the mounting hole in the storage rack, and a flange portion is brought into contact with a second vertical panel. An expanding shaft portion of the expansion member (30) is pushed into an inner peripheral portion of an expanded member, forming leg piece parts expanded to a dimension larger than the diameter of the rivet insertion hole on the leg piece parts projecting from the reinforcing thin sheet.

### TECHNICAL FIELD

The present technology relates to a mounting structure for fixtures of an aircraft lavatory unit.

### BACKGROUND ART

The wall panels constituting aircraft lavatory unit enclosures naturally need to be lightweight, in addition to being strong and rigid.

Such wall panels (panel members) have a configuration in which a surface member is adhered to both surfaces of a core member having a honeycomb structure to satisfy strength and rigidity requirements, and also to reduce weight (see Japanese Unexamined Patent Application Publication No. 2000-238154A).

The following are conventionally known mounting structures for mounting fixtures in aircraft lavatory units, such as storage racks and mirrors.

Namely, as illustrated in FIG. 8, a metal insert 40 with a pre-formed female screw 4002 is embedded in a wall panel 18. A metal screw 42 inserted into a fixture 10 is screwed into the female screw 4002 of the insert 40 via a metal washer 44, thereby mounting the fixture 10 to the wall panel 18. However, in the above-described conventional configuration, the metal insert 40 with a thickness thick enough to ensure the length of the female screw, the metal screw 42 and the metal washer 44 are used. Thus, there is room to improve the weight reduction and reducing component costs.

### SUMMARY

The present technology provides a mounting structure for an aircraft lavatory unit advantageous in ensuring the mounting strength of fixtures on a wall panel while reducing weight and cost.

The present technology is a mounting structure for mounting fixtures of an aircraft lavatory unit on a wall panel. The structure comprises a wall panel including a core member having a sheet shape, and a surface member composed of fiber-reinforced composite material having a sheet shape thinner than the core member, the surface member being arranged on both surfaces of the core member, and the surface member including an inner surface mounted on the core member and a surface opposite to the inner surface. A reinforcing thin sheet is mounted on the inner surface and/or the surface of the surface member at a location at which the fixture is arranged, and a rivet insertion hole is formed penetrating the surface member and the reinforcing thin sheet. A synthetic resin rivet includes a head portion abutting a part on the fixture, the part surrounding the mounting hole for the fixture, a shaft portion projecting from the head portion and inserted into the rivet insertion hole from the mounting hole for the fixture, and an expanding portion projecting from a tip of the shaft portion on the core member side, the expanding portion expanding to a dimension larger than a diameter of the rivet insertion hole. A part of the fixture provided with the mounting hole for the fixture, the surface member, and the reinforcing thin sheet are sandwiched between the head portion of the rivet and the expanding portion, to mount the fixture to the wall panel.

According to the present technology, providing the reinforcing thin sheet to ensure the mounting strength of the fixture on the wall panel and using a synthetic resin rivet to mount the fixture on the wall panel makes a configuration without a metal insert and a metal screw that are large in thickness possible, thus ensuring the mounting strength for the fixture on the wall panel while reducing the weight and component cost of an aircraft lavatory unit.

### BRIEF DESCRIPTION OF DRAWINGS

FIG. 1 is a cross-sectional view of a mounting structure for fixtures of an aircraft lavatory unit according to an embodiment of the present technology and illustrates a state in which a rivet is pre-assembled.

FIG. 2 is a cross-sectional view of the mounting structure for fixtures of an aircraft lavatory unit according to the embodiment of the present technology and illustrates a state in which the pre-assembled rivet is inserted in a mounting hole.

FIG. 3 is a cross-sectional view of the mounting structure for fixtures of an aircraft lavatory unit according to the embodiment of the present technology and illustrates a state in which an expanded member of the rivet expands and the fixture is mounted on a wall panel.

FIG. 4A is a front view of the expanded member of the rivet. FIG. 4B is a view from the direction of arrow B in FIG. 4A. FIG. 4C is a cross-sectional view in the direction of line C-C in FIG. 4A. FIG. 4D is a cross-sectional view in the direction of line D-D in FIG. 4B.

FIG. 5 is a front view of an expanding member of the rivet.

FIG. 6 is a cross-sectional view of the mounting structure for fixtures of an aircraft lavatory unit and illustrates a modified example of a reinforcing thin sheet mounted on the surface of a surface member.

FIG. 7 is a cross-sectional view of a mounting structure for fixtures of an aircraft lavatory unit and illustrates a modified example of reinforcing thin sheets mounted on the surface and inner surface of a surface member.

FIG. 8 is a cross-sectional view of a mounting structure for fixtures of an aircraft lavatory unit according to a comparative example.

### DETAILED DESCRIPTION

Next, a description will be given of a mounting structure for fixtures of an aircraft lavatory unit according to an embodiment of the present technology with reference to drawings.

First, a description will be given of a fixture.

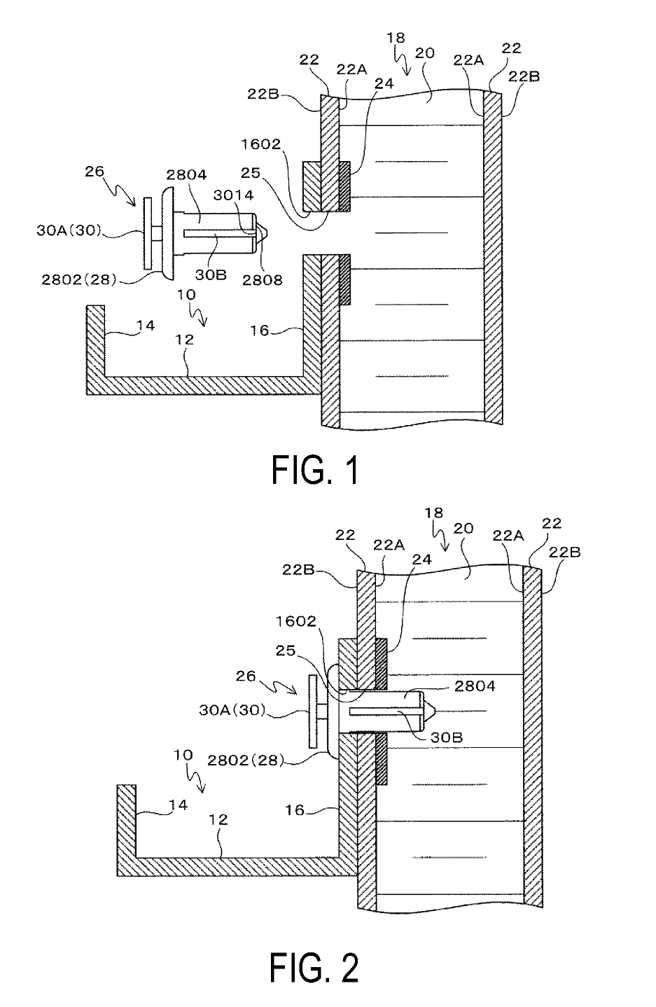

As illustrated in FIG. 1, a description is given of a fixture that is a synthetic resin storage rack 10 according to an embodiment of the present technology.

The storage rack 10 includes a rectangularly shaped base plate 12 having a width and a length longer than the width, a first vertical plate 14 standing on one side of the base plate 12 in the width direction, and a second vertical plate 16 having a height dimension higher than that of the first vertical plate 14 and standing on the other side of the base plate 12 in the width direction. The base plate 12 is a portion where the belongings of a user of an aircraft lavatory unit are temporarily placed.

A plurality of mounting holes 1602 are formed penetrating the second vertical plate 16 at intervals in the length direction of the second vertical plate 16.

Next, a description will be given of a wall panel of an aircraft lavatory unit.

As illustrated in FIG. 1, a wall panel 18 of an aircraft lavatory unit includes a core member 20 having a sheet shape, and a surface member 22 having a sheet shape thinner than the core member 20, the surface member 22 being arranged on both surfaces of the core member 20.

A conventionally known honeycomb structure of aramid fibers, glass fibers, aluminum, or the like may be used for the core member 20.

The surface member 22 includes an inner surface 22A mounted on the core member 20, and a surface 22B opposite to the inner surface 22A, the surface 22B constituting the surface of the wall panel 18.

Fiber-reinforced composite material composed of reinforced fibers and synthetic resin may be used as the surface member 22. A fabric composed of reinforced fibers such as glass, aramid, or carbon, or a sheet-shaped prepreg material of mono filament impregnated with synthetic resin such as phenolic resin or epoxy resin, may be used as the fiber-reinforced composite material.

The inner surfaces 22A of the surface member 22 are mounted on both surfaces of the core member 20 in the thickness direction by applying pressure and heat while the inner surfaces 22A of the surface member 22 are in a state of being stacked on both surfaces of the core member 20 in the thickness direction such that the resin impregnated in the surface member 22 is thermally cured and attached to both surfaces of the core member 20 in the thickness direction.

Next, a description will be given of a mounting structure for fixtures of an aircraft lavatory unit.

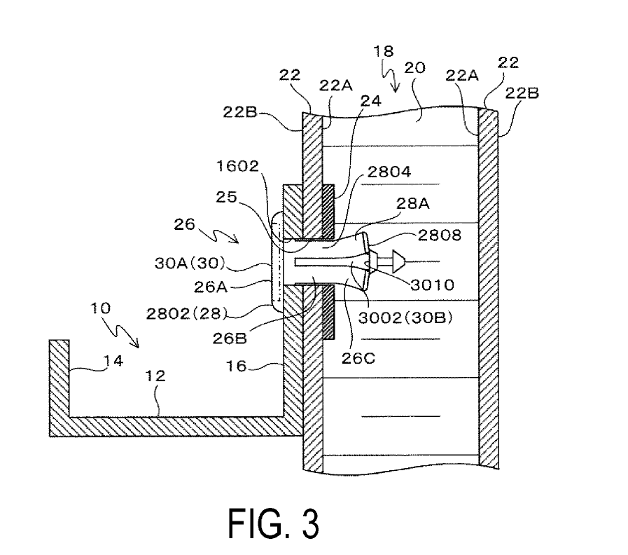

As illustrated in FIG. 3, the storage rack 10 is mounted on the wall panel 18 using a reinforcing thin sheet 24 and a rivet 26.

The reinforcing thin sheet 24 ensures the mounting strength of the wall panel 18 at a location at which the storage rack 10 is mounted, more specifically ensuring the mounting strength of surface member 22 at a location at which the storage rack 10 is mounted. The reinforcing thin sheet 24 has a thickness dimension smaller than the thickness of the surface member 22, which is advantageous in reducing weight and therefore preferable.

The reinforcing thin sheet 24 may be made of a metal such as an aluminum alloy or iron, the same fiber-reinforced composite material as a material used in the surface member 22, or a synthetic resin. The reinforcing thin sheet 24 made of synthetic resin is more advantageous in reducing weight.

Various conventionally known synthetic resins having superior strength and rigidity may be used to form the reinforcing thin sheet 24, including ultra high molecular weight polyethylene, polypropylene, polyacetal, polyamide, polycarbonate, modified polyphenylene ether, polybutylene terephthalate, polyethersulfone, polyphenylene sulfide, polyetheretherketone, fluororesin or the like.

The reinforcing thin sheet 24 is mounted on the inner surface 22A of the surface member 22 at a location at which the storage rack 10 is arranged.

A rivet insertion hole 25 is each formed penetrating the surface member 22 and the reinforcing thin sheet 24 at a location corresponding to each of the mounting holes 1602 of the storage rack 10.

Mounting the reinforcing thin sheet 24 on the inner surface 22A of the surface member 22 is done at the same time as mounting the above-described inner surfaces 22A of the surface member 22 on both surfaces of the core member 20 in the thickness direction, for example. Namely, pressure and heat are applied while the reinforcing thin sheet 24 is in a state of being stacked between the inner surface 22A of the surface member 22 and the core member 20, and the resin impregnated in the surface member 22 is thermally cured and attached to the reinforcing thin sheet 24. Otherwise, the reinforcing thin sheet 24 is adhered to the inner surface 22A of the surface member 22 with adhesive prior to applying pressure and heat to the surface member 22 and core member 20. Namely, the reinforcing thin sheet 24 is mounted on the inner surface 22A of the surface member 22.

The rivet insertion holes 25 penetrating the surface member 22 and reinforcing thin sheet 24 are machined from the surface 22B of the surface member 22 using a machining tool such as a drill press after the surface member 22, the reinforcing thin sheet 24 and the core member 20 are attached. Otherwise, the rivet insertion holes 25 may be formed penetrating the surface member 22 and the reinforcing thin sheet 24 prior to applying pressure and heat to the surface member 22 and the core member 20 while the reinforcing thin sheet 24 is in a state of being attached to the inner surface 22A of the surface member 22 with adhesive.

The rivet 26 is made of synthetic resin to reduce weight.

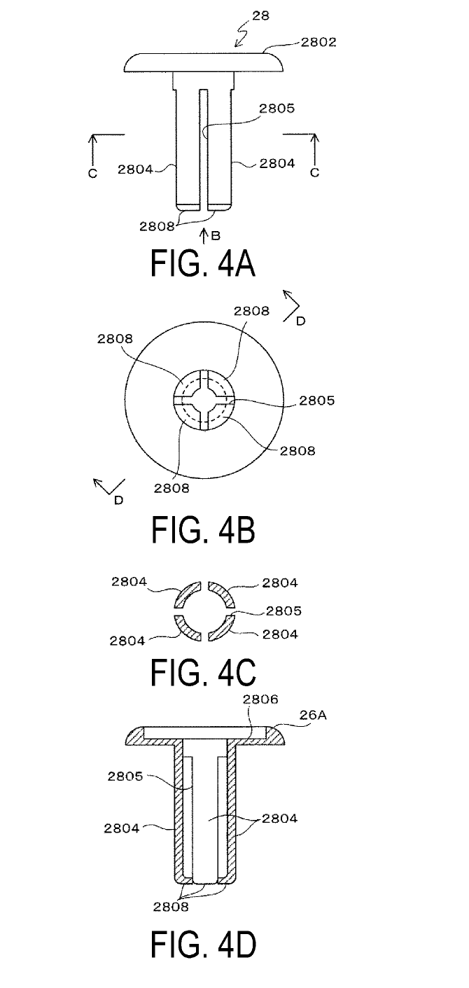

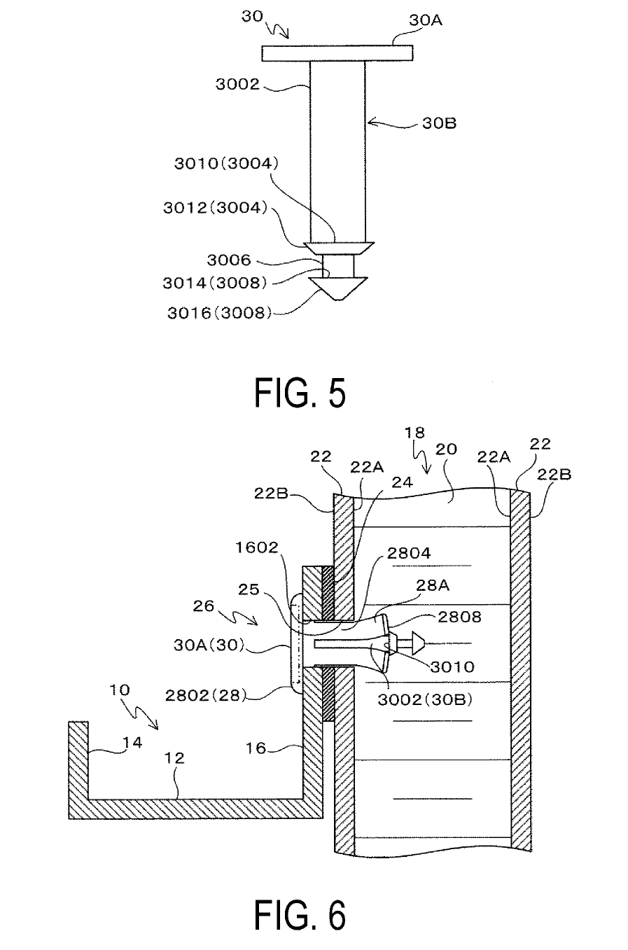

The rivet 26 comprises an expanded member 28 as illustrated in FIGS. 4A to 4D and an expanding member 30 as illustrated in FIG. 5. Both the expanded member 28 and expanding member 30 are made of synthetic resin.

As illustrated in FIGS. 4A to 4D, the expanded member 28 includes a flange portion 2802 and a plurality of leg pieces 2804.

The flange portion 2802, as illustrated in FIG. 3, has an annular shape, and is provided capable of abutting a location of the storage rack 10, the location surrounding the mounting hole 1602 (location on the second vertical plate 16).

An annular shaped housing recess portion 2806 is provided in the flange portion 2802.

The plurality of leg piece 2804 are provided projecting from the inner circumference of the flange portion 2802, and are inserted into the mounting hole 1602 and rivet insertion hole 25, and project from the reinforcing thin sheet 24 on the core member 20 side.

Four leg pieces 2804 are provided extending from the inner circumference of the flange portion 2802 in the shaft direction at equal intervals in the circumferential direction with slits 2805 formed between the adjacent leg pieces 2804.

Each of the leg pieces 2804 is capable of elastic deformation in the radial direction of the flange portion 2802, and the tip of each leg piece 2804 is a locking portion 2808 bent inward in the radial direction.

As illustrated in FIG. 5, the expanding member 30 includes an abutting portion 30A and an expanding shaft portion 30B.

The abutting portion 30A has a circular disc shape capable of abutting the bottom surface of the housing recess portion 2806 of the flange portion 2802.

The expanding shaft portion 30B projects from the bottom surface center of the abutting portion 30A and is inserted into the plurality of leg pieces 2804 from the inner circumference of the flange portion 2802. As illustrated in FIG. 3, the plurality of leg piece 2804 parts projecting from the reinforcing thin sheet 24 on the core member 20 side expand, and form leg piece parts 28A expanded to a dimension larger than the diameter of the rivet insertion hole 25.

According to the present embodiment, the expanding shaft portion 30B includes a first shaft portion 3002, a first bulging portion 3004, a second shaft portion 3006 and a second bulging portion 3008.

The first shaft portion 3002 has a circular cross section and projects from the bottom surface of the abutting portion 30A.

The first bulging portion 3004 is provided on the tip of the first shaft portion 3002.

The first bulging portion 3004 is formed by a first locking surface 3010 annularly expanding at the tip of the first shaft portion 3002, and a conical first inclined surface 3012 decreasing in diameter the further it is from the first locking surface 3010.

The second shaft portion 3006 projects from the first bulging portion 3004 concentric to the first shaft portion 3002, and is formed smaller in diameter than that of the first shaft portion 3002.

The second bulging portion 3008 is provided on the tip of the second shaft portion 3006.

The second bulging portion 3008 is formed by a second locking surface 3014 annularly expanding at the tip of the second shaft portion 3006, and a conical second inclined surface 3016 decreasing in diameter the further it is from the second locking surface 3014.

The expanded member 28 and the expanding member 30 are pre-assembled as illustrated in FIG. 1.

Namely, when the expanding shaft portion 30B of the expanding member 30 is inserted and pushed into the inner circumference of the expanded member 28, and the second inclined surface 3016 passes through the locking portion 2808 on the tip of each leg piece 2804, the locking portion 2808 of each of the leg pieces 2804 is disposed on the outer circumference of the second shaft portion 3006 and each of the leg pieces 2804 is in a closed state, and the locking portion 2808 of each of the leg pieces 2804 locks into the second locking surface 3014, resulting in a pre-assembled state without the expanding member 30 disengaging from the expanded member 28.

While in the pre-assembled state, the abutting portion 30A of the expanding member 30 and the bottom surface of the housing recess portion 2806 of the flange portion 2802 of the expanded member 28 are separated, and the abutting portion 30A projects from the flange portion 2802.

While the second vertical plate 16 of the storage rack 10 is in a state of overlapping the surface member 22 of the wall panel 18, and the mounting hole 1602 of the second vertical plate 16 is matching the rivet insertion hole 25 of the wall panel 18 and reinforcing thin sheet 24, as illustrated in FIG. 2, each of the leg pieces 2804 of the pre-assembled rivet 26 is inserted from the mounting hole 1602 of the storage rack 10 into the rivet insertion hole 25 of the wall panel 18 and reinforcing thin sheet 24, and the flange portion 2802 is brought into contact with the second vertical plate 16.

Here, as illustrated in FIG. 3, when the abutting portion 30A of the expanding member 30 is pressed until it makes contact with the bottom surface of the housing recess portion 2806 of the flange portion 2802, after the first inclined surface 3012 of the expanding shaft portion 30B of the expanding member 30 expands the locking portions 2808 of the four leg pieces 2804, the first inclined surface 3012 moves past the locking portions 2808. While in this state, each of the locking portions 2808 makes contact with the outer circumferential surface of the first shaft portion 3002.

Thus, the leg piece parts 28A are formed expanded to a dimension larger than the diameter of the rivet insertion hole 25 on the leg piece 2804 parts projecting from the reinforcing thin sheet 24.

In addition, each of the locking portions 2808 locks with the first locking surface 3010, holding the leg piece 2804 parts projecting from the reinforcing thin sheet 24 in an expanded state.

Consequently, in the present embodiment, as illustrated in FIG. 3, the head portion 26A of the rivet 26 comprises the flange portion 2802 and the abutting portion 30A.

In addition, the shaft portion 26B of the rivet 26 comprises a part closer to the flange portion 2802 of the leg piece portions 2804 and a part of the first shaft portion 3002 closer to the abutting portion 30A of the expanding shaft portion 30B.

In addition, the expanding part 26C of the rivet 26 comprises an expanded leg piece part 28A, and the tip of the first shaft portion 3002, which is distanced from the abutting portion 30A.

As a result, the part of the second vertical plate 16 provided with the mounting holes 1602, the surface member 22, and the reinforcing thin sheet 24 are sandwiched between the head portion 26A of the rivet 26 and the expanding part 26C of the rivet 26, to mount the storage rack 10 on the wall panel 18.

Furthermore, the rivet 26, for example, may provide a function making it possible to rotate the expanding member 30 inserted into the expanded member 28 in a prescribed direction so that each of the leg pieces 2804 closes to its original state, and the rivet 26 may be removed from the mounting hole 1602 and rivet insertion hole 25. The shape and structure of the synthetic resin rivet 26 is not limited to the present embodiment, and various conventionally known configurations may be used as long as the second vertical plate 16, the surface member 22, and the reinforcing thin sheet 24 are sandwiched in an overlapping state on both ends of the rivet 26 in the shaft direction.

According to the present embodiment, the mounting strength in a location on the wall panel 18 for mounting the storage rack 10 is ensured by the reinforcing thin sheet 24, and the storage rack 10 is mounted on the wall panel 18 of the aircraft lavatory unit with the synthetic resin rivets 26 while the second vertical plate 16, the surface member 22, and the reinforcing thin sheet 24 are overlapped and sandwiched between portions of the rivet 26.

Consequently, providing the reinforcing thin sheet 24 to ensure the mounting strength of a location on the wall panel 18 and using the synthetic resin rivets 26 to mount the storage rack 10 on the wall panel 18 make a configuration without metal inserts and metal screws that are large in thickness possible, which is advantageous in reducing the weight and component cost of the aircraft lavatory unit.

In addition, in the present embodiment, the expanding part 26C is formed by a very simple operation in which that the expanding member 30 of the rivet 26 is pressed into the expanded member 28, making it possible to mount the storage rack 10 on the wall panel 18, which is advantageous in simplifying mounting of the storage rack 10, and reducing the manufacturing cost of a lavatory unit.

Next, a description will be given of a modified example. Furthermore, this description shall emphasize differences from the above-described embodiment. Therefore, locations and members that are the same as in the above-described embodiment are assigned the same reference signs and their explanations shall be omitted.

In the above-described embodiment, the mounting of the reinforcing thin sheet 24 on the inner surface 22A of the surface member 22 at a location at which the storage rack 10 is arranged was described.

However, as illustrated in FIG. 6, the reinforcing thin sheet 24 may be mounted on the surface 22B of the surface member 22 with adhesive.

When this is done, it is possible to mount the storage rack 10 on the wall panel 18 later.

In addition, as illustrated in FIG. 7, the reinforcing thin sheet 24 may be mounted on the inner surface 22A and the surface 22B of the surface member 22.

This is advantageous in better ensuring the mounting strength for the storage rack 10 on the wall panel 18.

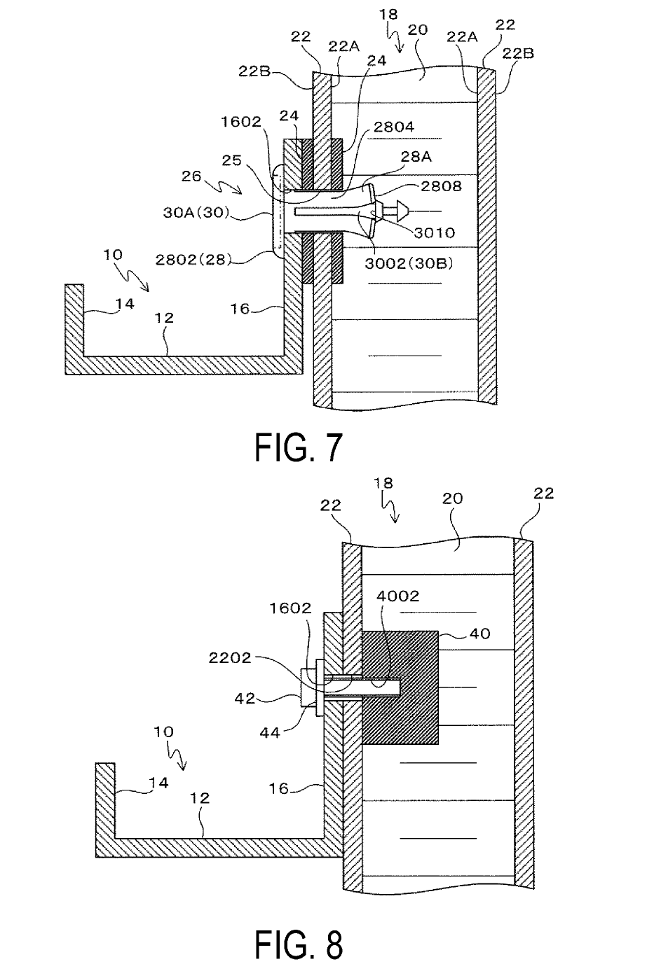

A description will be given of a comparative example with reference to FIG. 8.

In the comparative example, a metal insert 40 forming a female screw 4002 is embedded in a wall panel 18. A metal screw 42 is screwed into the female screw 4002 of the metal insert 40 via a metal washer 44, thereby mounting a storage rack 10 on the wall panel 18. Furthermore, a reference sign 2202 in the drawing illustrates a mounting hole formed penetrating the surface member 22.

Consequently, in the comparative example, three metal components are used for the metal insert 40 with sufficient thickness to ensure the length of the metal screw 42, the metal washer 44, the female screw 4002 of the metal screw 42, which is disadvantageous for reducing the weight and component cost of an aircraft lavatory unit.

In contrast, in the mounting structure for fixtures of an aircraft lavatory unit according to the present technology, the reinforcing thin sheet 24 and the synthetic resin rivets 26 are used, which is advantageous in ensuring the mounting strength for the storage rack 10 on the wall panel 18, and reducing the weight and component cost of an aircraft lavatory unit.

1. A mounting structure for mounting fixtures of an aircraft lavatory unit on a wall panel, the structure comprising:
a wall panel including
a core member having a sheet shape, and
a surface member composed of fiber-reinforced composite material having a sheet shape thinner than the core member,
the surface member being arranged on both surfaces of the core member, and
the surface member including
an inner surface mounted on the core member, and
a surface opposite to the inner surface;
a reinforcing thin sheet mounted on the inner surface and/or the surface of the surface member at a location at which a fixture is arranged;
a rivet insertion hole formed penetrating the surface member and the reinforcing thin sheet; and
a synthetic resin rivet including
a head portion abutting a part of the fixture, the part surrounding the mounting hole for the fixture,
a shaft portion projecting from the head portion and inserted into the rivet insertion hole from the mounting hole for the fixture, and
an expanding portion projecting at a tip of the shaft portion on the a core member side, the expanding portion expanding to a dimension larger than a diameter of the rivet insertion hole;
a part of the fixture provided with the mounting hole for the fixture, the surface member, and the reinforcing thin sheet being sandwiched between the head portion of the rivet and the expanding portion to mount the fixture to the wall panel.

2. The mounting structure for mounting fixtures of an aircraft lavatory unit according to claim 1, wherein:
the rivet comprises
a synthetic resin expanded member, and
a synthetic resin expanding member;
the expanded member includes
an annular shaped flange portion capable of abutting a part of the fixture, the part surrounding the mounting hole, and
a plurality of leg pieces provided projecting from an inner peripheral portion of the flange portion at intervals in a circumferential direction, inserted into the mounting hole and the rivet insertion hole, and projecting on the core member side;
the expanding member includes
an abutting portion capable of abutting the flange portion, and
an expanding shaft portion projecting on the core member side from the abutting portion that expands the plurality of leg pieces parts by being inserted into the plurality of leg pieces;
the head portion of the rivet comprises
the flange portion, and
the abutting portion;
the shaft portion of the rivet comprises
a part of a leg piece portion closer to the flange portion, and
a part of the expanding shaft portion closer to the abutting portion; and
the expanding portion of the rivet comprises
an expanded leg piece part, and
a tip portion of the expanding shaft portion separated from the abutting portion.

3. The mounting structure for mounting fixtures of an aircraft lavatory unit according to claim 1, wherein the rivet comprises
a synthetic resin expanded member, and
a synthetic resin expanding member.

4. The mounting structure for mounting fixtures of an aircraft lavatory unit according to claim 3, wherein the expanded member includes:
an annular shaped flange portion capable of abutting a part of the fixture, the part surrounding the mounting hole, and
a plurality of leg pieces provided projecting from an inner peripheral portion of the flange portion at intervals in a circumferential direction, inserted into the mounting hole and the rivet insertion hole, and projecting on the core member side.

5. The mounting structure for mounting fixtures of an aircraft lavatory unit according to claim 4, wherein the expanding member includes:
an abutting portion capable of abutting the flange portion, and
an expanding shaft portion projecting on the core member side from the abutting portion that expands the plurality of leg pieces by being inserted into the plurality of leg pieces.

6. The mounting structure for mounting fixtures of an aircraft lavatory unit according to claim 5, wherein the head portion of the rivet comprises:
the flange portion, and
the abutting portion;

7. The mounting structure for mounting fixtures of an aircraft lavatory unit according to claim 5, wherein the shaft portion of the rivet comprises:
a part of the leg piece portion closer to the flange portion, and
a part of the expanding shaft portion closer to the abutting portion.

8. The mounting structure for mounting fixtures of an aircraft lavatory unit according to claim 5, wherein the expanding portion of the rivet comprises:
an expanded leg piece part, and
a tip portion of the expanding shaft portion separated from the abutting portion.
